(19) United States
(12) Patent Application Publication
(10) Pub. No.: US 2020/0028995 A1
(43) Pub. Date: Jan. 23, 2020

(54) ADAPTER SYSTEM FOR MOUNTING AN IMAGE AND VIDEO CAPTURING DEVICE TO AN OPTICAL VIEWING DEVICE AND A METHOD OF OBSERVING THE IMAGES AND VIDEOS

(71) Applicant: LABOTECH MICROSCOPES INDIA PVT LTD, Ambala Cantt (IN)

(72) Inventor: Neeraj JAIN, Ambala Cantt (IN)

(21) Appl. No.: 16/426,870

(22) Filed: May 30, 2019

(30) Foreign Application Priority Data
Jul. 19, 2018 (IN) 201811027056

(51) Int. Cl. H04N 5/225; G03B 17/56; G03B 17/48

(52) U.S. Cl. CPC H04N 5/2252; G02B 23/16; G03B 17/48; G03B 17/561

(57) ABSTRACT

An adapter system for mounting an image and video capturing device to an optical viewing device includes a video adapter tube, an adapter tube, a support plate and a cover. An image and video capturing device is connected to the adapter tube through a support plate affixed on the cover where the adapter tube is then connected to the video adapter tube which is further connected to an optical viewing device through an image divider beam splitter. Also, there are image rotation features which makes the adapter assembly unique and more convenient. A method is also disclosed of observing the images and videos with an optical viewing device, by using an adapter system.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to an adapter system for mounting an image and video capturing device to an optical viewing device.

More particularly, it relates to a method of observing the images and videos with an optical viewing device, by using an adapter system

### 2. Description of Related Art Including Information Disclosed Under 37 CFR 1.97 and 37 CFR 1.98

Photomicrographs in Anatomic Pathology provide a means of quickly sharing information from a glass slide for consultation, education, documentation, and publication. While static image acquisition historically involved the use of a permanently mounted camera unit on a microscope, such cameras may be expensive, need to be connected to a computer, and often require proprietary software to acquire and process images.

Video recording and still photography is an essential component for documenting surgical and clinical details. Additionally, videos have an important role in skill transfer, demonstration of new procedures, and as the material of clinical evidence.

Reference may be taken from U.S. Pat. No. 9,438,773 which discloses A universal adapter system having a video camera mount and a digital camera mount for attaching a video camera and a digital camera to a single port of an optical observation device, such as a standard microscope, that allows for simultaneous video and digital camera imaging. An example digital camera mount includes a C-clamp attachment for attaching a standard, off-the-shelf digital camera and a sleeve attached to the adapter housing that allows the use of an extendable zoom lens of the digital camera. The adapter may provide increased capabilities by use of a rotatable portion to allow positioning of the digital camera relative to the optical observation device, a parfocal zoom lens for simultaneous zoom adjustment of video and digital cameras, an auxiliary zoom lens, a fine focus adjustment for adjusting the video image independent of the digital image, a smartphone adapter, a Toric reticule and a light filter.

Another reference may be taken from the U.S. Pat. No. 5,264,928A which discloses an adapter system for mounting a video camera and optionally a 35-mm camera on a microscope beam splitter comprises a main body housing and a nose piece which is detachably secured in the main body housing. A plurality of lens cartridges may be mounted within the nose piece to focus light on a beam splitter mounted within the main body housing. The beam splitter provides an image along both an axial beam path and a transverse beam path relative to the main body housing. A video camera may be mounted on the transverse axis to receive and image with a magnification depending on the focal length of the lens cartridge. A 35-mm camera may be attached to the main body housing on the axial beam path to receive an image having a focally depending both on the lens cartridge as well as on a separate single or compound lens located between the beam splitter and the 35-mm camera. Conveniently, mounting rings for either a bayonet-type mount or C-type mount may be provided for receiving the video camera.

Another novel approach for capturing digital microscopic images is to use smartphones coupled with the eyepiece of a microscope. Above referenced patent Applications do not describe the use of Smartphone. On the other hand, present invention approaches the use of smartphone adapters that allow users to attach mobile phones to the microscope.

Smartphone adapters are inexpensive and easy to use for acquiring digital microscopic images. However, they require some adjustment by the user in order to optimize focus and obtain good quality images. Smartphone microscope adapters provide an economically feasible method of acquiring and sharing digital pathology photomicrographs.

Another reference may be taken from U.S. Pat. No. 8,842,981 which relates to an adapter for holding a camera lens of a smartphone, digital mobile device or other camera-bearing device in alignment with an optical instrument has an optical instrument coupler with a pair of spaced-apart clamp members, one of which is used to clamp onto an eyepiece of the optical instrument, and a camera-bearing device coupler having a device clamp member which is used to clamp the camera-bearing device so that its camera lens is in optical alignment with the clamped eyepiece of the optical instrument. A mounting plate with a camera lens slot and a linearly movable locking bracket for the optical instrument coupler enables the position of the camera lens to be adjusted in alignment with the eyepiece of the optical instrument.

Further reference may be taken from U.S. Pat. No. 9,122,131 which relates to relates to methods and devices for mounting an image capture device to an optical viewing instrument such as a microscope, telescope, or binocular. More specifically, some embodiments of the present invention relate to an apparatus for mounting a smartphone to an observation tube of the microscope. The optical viewing instrument may have an observation tube and an ocular attached thereto. The adapter may include an observation tube ring mount configured to be installed on the observation tube. An observation tube mount may be configured to engage with the installed ring mount. An image capture device holder may be configured to couple with the observation tube mount and configured to receive an image capture device. The image capture device may be a common device such as a smartphone. Optionally, a window may be included in the observation tube mount to facilitate viewing of ocular indicia.

Though above inventions are for Smartphone, however, these are limited by mounting only on the eyepiece of observation head, there is no beam splitter and image rotation features of the present invention which makes present adapter assembly unique and more convenient.

### OBJECTS OF THE INVENTION

The main object of the present invention is to provide an adapter system for mounting an image and video capturing device to an optical viewing which obviates the drawbacks of the earlier adapter system.

In another object of the present invention is to provide an adapter system which is ergonomically in use to allow the adaptation of smartphone in any desired position without rotating the camera and digital rotating imager.

It is yet another object of the present invention is to provide an adapter system with increased capabilities of image rotation by use of a rotating optical module without disturbing the smartphone.

It is yet another object of the present invention is to provide a method of observing the images and videos with an optical viewing device a device.

### BRIEF SUMMARY OF THE INVENTION

The present invention provides an adapter system for mounting an image and video capturing device to an optical viewing device which includes a video adapter tube, adapter tube, a support plate and a cover. An image and video capturing device is connected to the adapter tube through a support plate affixed on the cover. Adapter tube is then connected to the video adapter tube which is further connected to an optical viewing device through an image divider beam splitter.

The invention is also related to a method of observing the images and videos with an optical viewing device, by using an adapter system.

### BRIEF DESCRIPTION OF THE SEVERAL VIEWS OF THE DRAWINGS

The disclosure will provide details in the following description of preferred embodiments with reference to the following drawings, wherein:

FIG. 1 depicts the design of adapter system assembly.

FIG. 2 illustrates the elaborated version of the beam splitter, an image and video capturing device, an optical viewing device, where a video adapter tube, adapter tube, a support plate and a cover is shown.

FIG. 3 illustrates the cubic shaped structure of beam splitter which splits the incident light of optical viewing device equally to the image and video capturing device through an optical coupler and to the observer's eye.

The above summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The following detailed description is merely exemplary in nature and is to enable any person skilled in the art to make and use the invention. The description is not intended to limit the application and uses of the various embodiments. Various modifications to the disclosed invention will be readily apparent to those skilled in the art, and the methodology defined herein may be applied to other embodiments and applications without departing from the spirit and the scope of the present disclosure.

The foregoing objects of the present disclosure are accomplished and the problems and shortcomings associated with the prior art, and approaches are overcome by the present disclosure, as described below in the preferred embodiments.

Accordingly, the present invention provides an adapter system for mounting an image and video capturing device to an optical viewing device, wherein the said adapter system comprising

a) an image and video capturing device having a video adapter tube, an adapter tube, a support plate and a cover;

b) beam splitter connected to the optical viewing device which is oriented to receive light and divide it equally on the observer's eye and to an image and video capturing device through an optical coupler;

c) an optical viewing device attached to an image and video capturing device through beam splitter wherein the optical viewing device having an entrance end configured to attach to an optical port of the optical viewing device in such a way that when incident light passes through the entrance end it splits through beam splitter and half portion of the reflected light enters to the image and video capturing device through video adapter tube and rest of the half portion of incident light enters to the observer's eye;

wherein an image and video capturing device is connected to the adapter tube through support plate affixed on the cover wherein the adapter tube is further connected to video adapter tube which is coupled to optical viewing device through an image divider beam splitter.

In an embodiment of the present invention, the optical viewing device comprises the surgical microscope or a biomicroscope.

In another embodiment of the present invention, the image and video capturing device used is Smartphone.

Further, in an embodiment of the present invention, the adapter further includes a rotating optical module that attaches to the image and video capturing device.

Yet, in an embodiment of the present invention, the beam splitter is prepared by using two typically right angle prisms wherein the hypotenuse surface of one prism is coated, and the two prisms are cemented together to obtain a cubic shaped structure wherein two such cubic shaped structures are used in the said beam splitter.

Still, in an embodiment of the present invention, the beam splitter directs a half portion of the incident light of optical viewing device to the image and video capturing device through an optical coupler and rest half portion of the incident light to the observer's eye.

Still, in an embodiment of the present invention, the beam splitter splits the incident light into reflection light and divided light having a wavelength ranges between 400-700 nm.

The present invention also provides a method of observing the images and videos with an optical viewing device, by using an adapter system wherein the said method comprising the steps of:

a) directing a beam of light to the beam splitter connected with the optical viewing device through an entrance end of optical viewing device;

b) splitting the equal portion of the beam of light and directs it half portion of the incident to the image and video capturing device attached to the adapter tube and half portion of incident light to the observer's eye;

c) digital and video imaging to the adapter tube attached to the adapter system. In an embodiment of the present invention, the beam splitter directs a half portion of the incident light of optical viewing device to the image and video capturing device through an optical coupler and half portion of the incident light to the observer's eye.

Further, in an embodiment of the present invention, the images and videos are observed in any desired position without rotating the camera and digital rotating imager.

Exemplary embodiments of the present general inventive concept provide an adapter system for mounting an image and video capturing device (1) to an optical viewing device (3) which includes a video adapter tube (5), adapter tube (6), a support plate (7) and a cover (8), where an image and video capturing device (1) is connected to the adapter tube (6) through a support plate (7) which is affixed on the cover (8). Adapter tube (6) is further connected to a video adapter tube (5) which is then connected to an optical viewing device (3) through an image divider beam splitter (2).

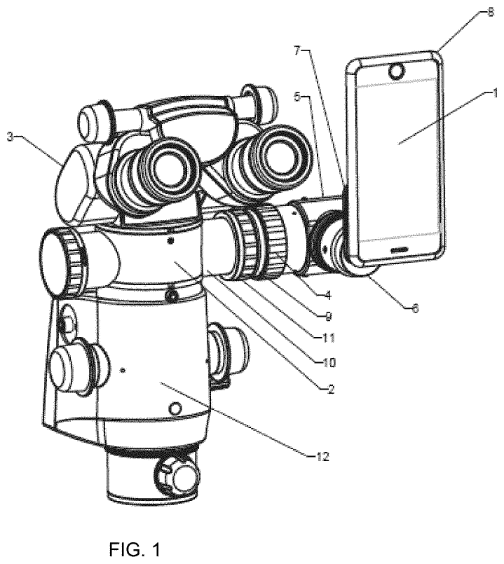

Reference is now made to FIG. 1 where an adapter system is mounting on an image and video capturing device (1) which is then connected to the optical viewing device such as a surgical microscope (12). The image and video capturing device (1) includes a video adapter tube (5), an adapter tube (6), a support plate (7) and a cover (8). The said adapter system further includes a beam splitter (2) which is oriented to receive light (13) and divide it to an image and video capturing device (1) through an optical coupler (11).

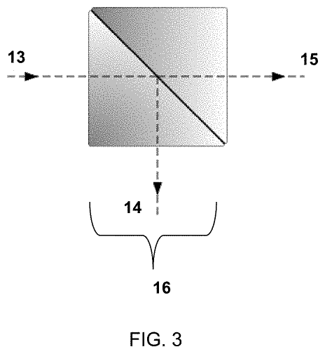

The beam splitter (2) is constructed using two typically right angle prisms of the designed glass as shown in FIG. 3. The hypotenuse surface of one prism is coated with a mixture of silicon oxide and tantalum oxide, and the two prisms are cemented together so that a cubic shaped structure (16) is formed. The thickness of the coating layer is adjusted such that (for a certain wavelength) half of the incident light (13) passing through one “port” (i.e., face of the cube) is reflected as (14) after hitting the hypotenuse and the other half is transmitted as the divided light (15). The thickness of the coating layer is adjusted in such a manner by increasing or decreeing the layers of coatings so that reflected light and divided light can achieve the lights of wavelength in between 400 nm-700 nm.

In present beam splitter (2), there is two such cubics shaped structure (16) used in beam splitter housing to cover light rays for both eyes. Referring the FIG. 3, incident light (13) from an entrance end of optical viewing device (9) a divided light (15) goes into observer eye and light reflected as (14) goes to an image and video capturing device (1) through the adapter.

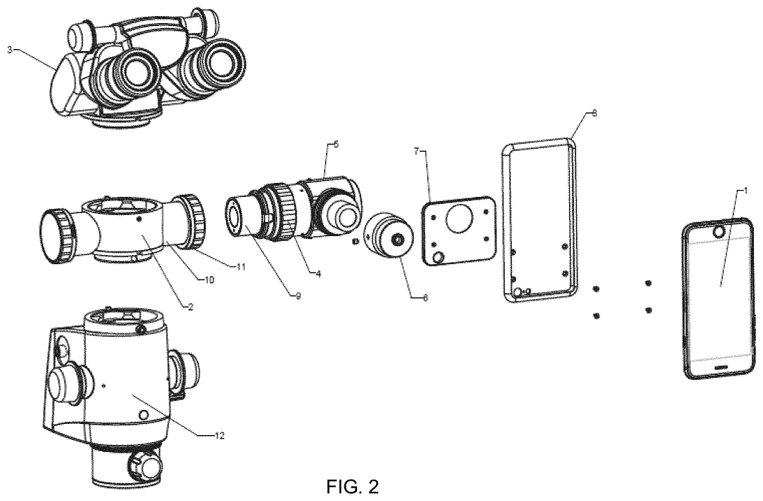

FIG. 2 shows the assembly of each component of present adapter system how it is mounted on image and video capturing device (1) and attached to an optical viewing device (3) through a beam splitter (2). The optical viewing device (3) having an entrance end (9) configured to attach to an optical port (10) of the optical viewing device (3). The incident light (13) passes through the entrance end (9) of the optical viewing device (3) where it divides through beam splitter (2) and the divided light (15) transmitted to observer's eye and reflected light (14) passed on an image and video capturing device (1) through video adapter tube (5), wherein reflected light (14) is equally in portion to the divided light (15).

The image and video capturing device (1) is connected to the adapter tube (6) through the support plate (7) which is affixed on the cover (8).

The adapter tube (6) is further connected to video adapter tube (5) which is attached to an optical viewing device (3) through an image divider beam splitter (2) as shown in FIGS. 1 & 2.

Here the surgical microscope is being used s an optical viewing device (3) however any kind of the microscope, bioscope can be used to execute the objective of the present invention. Likewise, a Smartphone as an image and video capturing device (1) is being used here to perform the objective of the technology, however, any camera and video with the high-performance device can be used.

Refereeing to FIGS. 1 and 2, a rotating optical module (4) is used in the adaptor which is connected to the image and video capturing device (1), which allows the image and video capturing device (1) in any desired position without rotating the camera and digital rotating imager.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

### REFERENCE NUMERALS

1. an image and video capturing device
2. beam splitter
3. an optical viewing device
4. a rotating optical module
5. a video adapter tube
6. an adapter tube
7. a support plate
8. a cover
9. an entrance end of an optical viewing device
10. an optical port of the optical viewing device
11. an optical coupler
12. a surgical microscope
13 an incident light
14. reflected light
15. divided light
16. cubic shaped structure

### Advantages of the Present Invention

1. The present Smartphone adapter is inexpensive and easy to use for acquiring digital microscopic images.

2. The present Smartphone adapter allows the adaptation of the smartphone in any desired position without rotating the camera and digital rotating imager.

3. The present invention provides increased capabilities of image rotation by use of a rotating optical module without disturbing the smart phone.

4. The present adapter provides an economically feasible method of acquiring and sharing digital pathology photomicrographs.

1. An adapter system for mounting an image and video capturing device to an optical viewing device, wherein the said adapter system comprises:
an image and video capturing device having a video adapter tube, an adapter tube, a support plate and a cover;
a beam splitter connected to the optical viewing device which is oriented to receive light and divide it equally on the observer's eye and to an image and video capturing device through an optical coupler;
an optical viewing device attached to an image and video capturing device through beam splitter wherein the optical viewing device has an entrance end configured to attach to an optical port of the optical viewing device in such a way that when incident light passes through the entrance end, it splits through beam splitter and half portion of the reflected light and enters to the an image and video capturing device through video adapter tube and rest half of the portion of incident light enters the observer's eye;
wherein an image and video capturing device is connected to the adapter tube through support plate affixed on the cover wherein the adapter tube is further connected to video adapter tube which is coupled to optical viewing device through an image divider beam splitter.

2. The adapter system as claimed in claim 1, wherein the optical viewing device comprises a surgical microscope or a bio microscope.

3. The adapter system as claimed in claim 1, wherein the image and video capturing device used is a Smartphone.

4. The adapter system as claimed in claim 1, wherein the said adapter includes a rotating optical module that attaches to the image and video capturing device.

5. The adapter system as claimed in claim 1, wherein the beam splitter is prepared by using two typically right angle prisms wherein the hypotenuse surface of one prism is coated with a mixture of silicon oxide and tantalum oxide wherein two such coated prisms are cemented together to obtain a cubic shaped structure wherein two such cubic shaped structures are used in the said beam splitter.

6. The adapter system as claimed in claim 5, wherein the said beam splitter directs a half portion of the incident light of optical viewing device to the image and video capturing device through an optical coupler and rest half portion of the incident light to the observer eye.

7. The adapter system as claimed in claim 6, wherein the beam splitter splits the incident light into reflection light and divided light having a wavelength ranges between 400-700 nm.

8. A method of observing the images and videos with an optical viewing device, by using an adapter system of claim 1, wherein the said method comprises the steps of:
a) directing a beam of light to the beam splitter connected with the optical viewing device through an entrance end of optical viewing device;
b) splitting the equal portion of the beam of light and directs it half portion of the incident to the image and video capturing device attached to the adapter tube and half portion of incident light to the observer's eye; and
c) digital and video imaging to the adapter tube attached to the adapter system.

9. The method of observing the images and videos as claimed in claim 8, wherein the said beam splitter directs a half portion of the incident light of optical viewing device to the image and video capturing device through an optical coupler and half portion of the incident light to the observer's eye.

10. The method as claimed in claim 9, wherein the images and videos are observed in any desired position without rotating the camera and digital rotating imager.
